(19) United States
(12) Patent Application Publication
(10) Pub. No.: US 2014/0327635 A1
(43) Pub. Date: Nov. 6, 2014

(54) TOUCH ELECTRONIC DEVICE

(71) Applicants: Chi-Ming Huang, Taichung City (TW); Ming-Chuan Lin, Taichung City (TW); Hsueh-Chih Wu, Taichung City (TW)

(72) Inventors: Chi-Ming Huang, Taichung City (TW); Ming-Chuan Lin, Taichung City (TW); Hsueh-Chih Wu, Taichung City (TW)

(73) Assignee: WINTEK CORPORATION, Taichung City (TW)

(21) Appl. No.: 14/267,926

(22) Filed: May 2, 2014

(30) Foreign Application Priority Data
May 2, 2013 (TW) 102115725

(51) Int. Cl. G06F 3/041

(52) U.S. Cl. CPC G06F 3/041
USPC 345/173

(57) ABSTRACT

A touch electronic device is provided. The touch electronic device includes a main touch region, a decoration region, an assistant touch region, and a sensing module. The decoration region is disposed at or on at least one side of the main touch region. The assistant touch region is in the decoration region, and has at least one hot key, and the at least one hot key is configured to execute a preset function. The sensing module is configured to activate or deactivate the preset function of the at least one hot key.

### CROSS-REFERENCE TO RELATED APPLICATION

This application claims the priority benefit of Taiwan application serial no. 102115725, filed on May 2, 2013. The entirety of the above-mentioned patent application is hereby incorporated by reference herein and made a part of this specification.

### BACKGROUND OF THE INVENTION

1. Field of the Invention

The invention relates to a touch electronic device, and more particularly, to a touch electronic device capable of effectively avoiding inadvertent operation.

2. Description of Related Art

In the modern hectic everyday life, emphasizing convenience and efficiency in everything has become a very common lifestyle. Present smart end products are, for instance, handheld devices such as the smart phone or the tablet PC, which not only must be powerful and compact at the same time, the user usually also prefers being able to activate and operate the desired function in a very short amount of time. This is especially true for the more frequently used functions of the user (such as editing a text message, inquiring call history, or returning to the homepage).

Therefore, to meet these requirements, present manufacturers of smart end products, in the case of smart phones, almost always arrange a shortcut key or a hot key in the decoration region of the smart phone at the beginning of the design. Accordingly, when the user presses the hot key, the commonly used corresponding function can be quickly activated, thereby shortening the time required for searching and activating the function and increasing the convenience of use.

However, when the modern user operates the smart end product, because operations such as a significant amount of touching and sliding are needed on the main touch region of the touch panel to execute or operate the various functions in the phone, it is difficult to avoid inadvertently touching the shortcut key or the hot key on the phone when the user engages in the execution or operation of different functions, which causes incorrect execution of nonessential functions and significantly increases inconvenience of use.

### SUMMARY OF THE INVENTION

The invention provides a touch electronic device. The touch electronic device can activate or deactivate a preset function of a hot key on the touch electronic device through a sensing module on the touch electronic device, thereby effectively reducing the occurrence of the user inadvertently touching the hot key when using the touch electronic device.

The invention provides a touch electronic device. The touch electronic device includes a main touch region, at least one hot key, and a sensing module. The at least one hot key is configured to execute a preset function. The sensing module is configured to activate or deactivate the preset function of the at least one hot key.

In an embodiment of the invention, a decoration region and an assistant touch region are further included. The decoration region is disposed at or on at least one side of the main touch region. The assistant touch region is in the decoration region and the at least one hot key is in the assistant touch region.

In an embodiment of the invention, the sensing module includes at least one virtual key, an actuation thereof having a higher priority compared to the at least one hot key, the at least one virtual key is disposed in the decoration region, and the at least one virtual key is configured to activate or deactivate the preset function of the at least one hot key when the at least one virtual key and the at least one hot key are started at the same time.

In an embodiment of the invention, the at least one virtue key is disposed between the at least one hot key and the main touch region.

In an embodiment of the invention, the at least one virtue key surrounds a portion of the at least one hot key.

In an embodiment of the invention, the at least one hot key includes a plurality of distinct hot keys, the sensing module includes a touch sensor coupled to the hot keys, and the touch sensor is configured to sense a press sequence of the plurality of hot keys and determine whether the press sequence conforms to a preset press sequence to activate or deactivate the preset function of the at least one hot key.

In an embodiment of the invention, the sensing module includes a gravity sensor, a voice sensor, or an application. The gravity sensor is used for sensing a change in position of the touch electronic device to activate or deactivate the preset function of the at least one hot key. The voice sensor is used for sensing a voice input of a user to the touch electronic device to activate or deactivate the preset function of the at least one hot key. The application is used for sensing if the user started the application, and the preset function of the at least one hot key is activated or deactivated in response to whether the application is activated.

Based on the above, the electronic device provided in the invention effectively reduces the problem of the user inadvertently touching the hot key when operating the electronic device through the arrangement of the virtual key and the hot key or through other embodiments. Therefore, the convenience of using the electronic device can be significantly enhanced.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a touch electronic device according to the first embodiment of the invention.

FIG. 2 is a schematic diagram of a touch electronic device according to the second embodiment of the invention.

FIG. 3 is a schematic diagram of a touch electronic device according to the third embodiment of the invention.

FIG. 4 is a schematic diagram of a touch electronic device according to the fourth embodiment of the invention.

FIG. 5 is a schematic diagram of a touch electronic device according to the fifth embodiment of the invention.

FIG. 6 is a schematic diagram of a touch electronic device according to the sixth embodiment of the invention.

FIG. 7 is a schematic diagram of a touch electronic device according to the seventh embodiment of the invention.

FIG. 8 is a schematic diagram of a touch electronic device according to the eighth embodiment of the invention.

### DESCRIPTION OF THE EMBODIMENTS

Descriptions of the invention are given with reference to the exemplary embodiments illustrated with accompanied drawings, wherein same or similar parts are denoted with same reference numerals. In addition, whenever possible, identical or similar reference numbers stand for identical or similar elements in the figures and the embodiments.

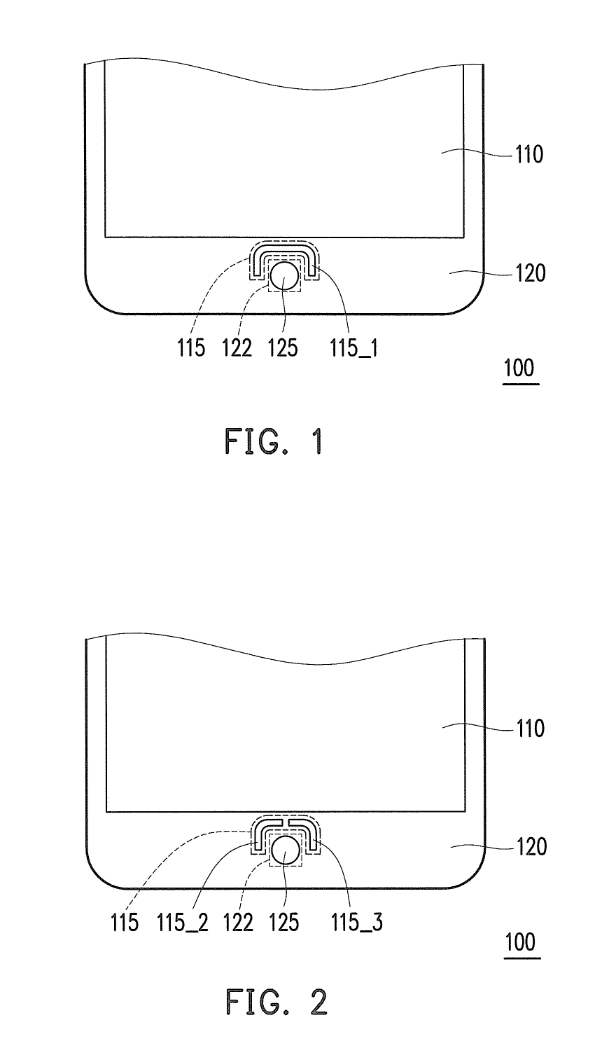

FIG. 1 is a schematic diagram of a touch electronic device according to the first embodiment of the invention. Referring to FIG. 1, a touch electronic device 100 includes a main touch region 110, a decoration region 120, an assistant (or auxiliary) touch region 122, and a sensing module 115. In particular, the decoration region 120 is exemplified in the invention as being disposed at or on the four sides of the touch electrode device 100 and surrounding the main touch region 110, but the invention is not limited thereto. The decoration region 120 can also be disposed only at or on at least one side of the touch electrode device 100 according to design requirements, such as at or on at least one side of the main touch region 110. The assistant touch region 122 is in the decoration region 120 and includes at least one hot key (also referred to as a shortcut key) 125, and different preset functions are built in the hot key 125, common examples of which are the home key and the search key . . . etc., to provide the user more convenient selections of functions during use. In the present embodiment, the touch electronic device 100 can be an electronic device having touch function, such as a smart phone, a personal digital assistant (PDA), or a tablet PC, but the invention is not limited thereto.

The main touch region 110 of the touch electronic device 100 can for instance be a capacitive touch screen, wherein a plurality of inductive electrodes (not illustrated) made of a transparent electrode (such as indium tin oxide (ITO) or a similar material) or a metal mesh made of a single-layer or a multi-layer metal material are disposed therein or thereon. The inductive electrodes can detect and receive operations such as pressing and sliding of the user through a finger or other mediums using operating modes of self-capacitance or mutual-capacitance or a combination of both thereof, to be used as the input/output (I/O) interface of the touch electronic device 100 at the same time. However, the main touch region 110 of the touch electrode device 100 can also be a resistive touch screen or an optical touch screen . . . etc., but the invention is not limited thereto. Moreover, the touch electronic device 100 can also be used with a display interface such as a liquid crystal display (LCD), an organic light-emitting device (OLED), or other suitable display interfaces to display the various operation/execution frames/images of the touch electronic display device 100.

In the present embodiment, the sensing module 115 of the touch electronic device 100 is a virtual key 115_1 in the decoration region 120. In other words, the sensing module 115 is implemented through the virtual key 115_1, the virtual key 115_1 is disposed between the hot key 125 and the main touch region 110, and surrounds a portion of the hot key 125 (as shown in FIG. 1) to be used as a separator between the hot key 125 and the main touch region 110. In particular, the function of the virtual key 115_1 is that, when the virtual key 115_1 is pressed or touched by the user, the corresponding preset function of the hot key 125 is deactivated. Moreover, in the present embodiment, the arrangement/configuration and operation of the virtual key 115_1 of the sensing module 115 can be achieved in the same manner as the inductive electrodes in the main touch region 110. Furthermore, the arrangement/configuration and operation of the hot key 125 can also be achieved in the same manner as the inductive electrodes in the main touch region 110.

It should be mentioned that, the priority setting of the virtual key 115_1 in the touch electrode device 100 is that the virtual key 115_1 has a higher priority compared to the hot key 125. Therefore, if the finger of the user inadvertently presses the virtual key 115_1 and the hot key 125 successively/at the same time when sliding on the main touch region 110, the touch electronic device 100 will still deactivate the preset function of the hot key 125 by using the function of the virtual key 115_1 in precedence, thereby effectively avoiding the execution of a nonessential preset function when the user inadvertently touches the hot key 125 during operation of the touch electronic device 100. In the present embodiment, although only one hot key 125 and one virtual key 115_1 are illustrated, but the invention is not limited thereto, the number of the hot keys and virtual keys of the touch electronic device can be decided on the actual design/application requirements.

For instance, referring next to FIG. 2, FIG. 2 is a schematic diagram of a touch electronic device according to the second embodiment of the invention. The difference between the present embodiment and the first embodiment is that the decoration region 120 of the touch electrode device 100 includes two virtual keys 115_2 and 115_3 and an assistant (or auxiliary) touch region 122 therein. The assistant touch region 122 includes a hot key 125, wherein the virtual keys 115_2 and 115_3 are similarly disposed between the hot key 125 and the main touch region 110, the virtual keys 115_2 and 115_3 respectively surround a portion of the hot key 125 (as shown in FIG. 2), and are used as a separator between the hot key 125 and the main touch region 110. Therefore, the problem of inadvertently touching the hot key 125 due to sliding from different directions or angles can be effectively avoided when the user operates the touch electrode device 100.

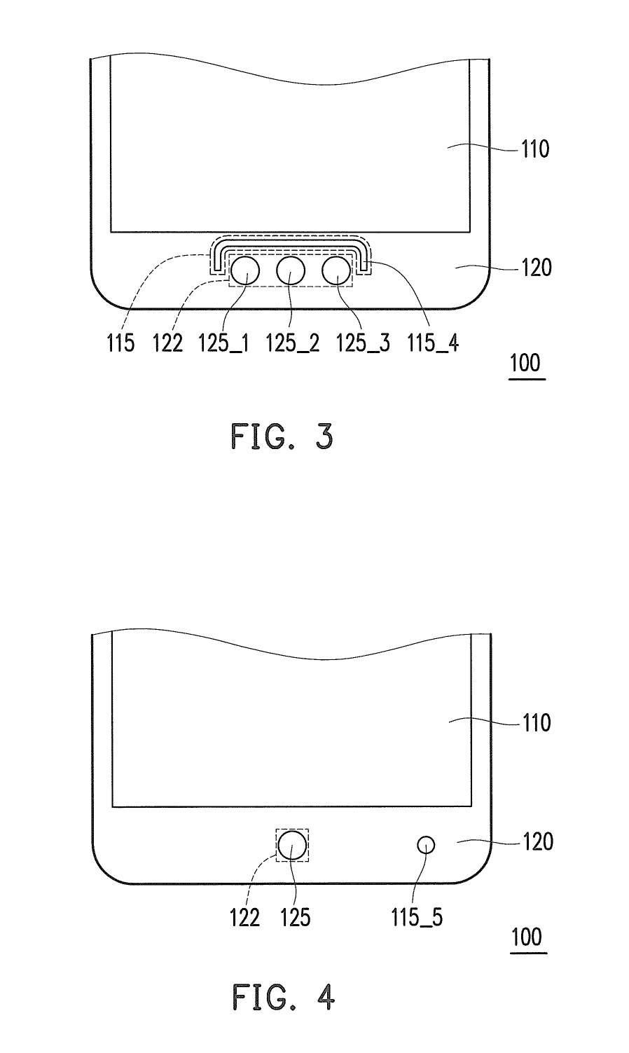

Referring next to FIG. 3, FIG. 3 is a schematic diagram of a touch electronic device according to the third embodiment of the invention. The difference between the present embodiment and the first embodiment is that the decoration region 120 of the touch electronic device 100 includes a virtual key 115_4 and an assistant (or auxiliary) touch region 122 therein, and the assistant touch region 122 includes three distinct hot keys 125_1, 125_2, and 125_3. In particular, the virtual key 115_4 is disposed between the hot keys 125_1, 125_2, and 125_3 and the main touch region 110, surrounds a portion of the assistant touch region 122 (i.e. the three hot keys 125_1, 125_2, and 125_3, as shown in FIG. 3), and is used as a separator between the hot keys 125_1, 125_2, and 125_3 and the main touch region 110. Therefore, the problem of inadvertently touching a plurality of the hot keys 125_1, 125_2, and 125_3 or one thereof when the user operates the touch electronic device 100 can be effectively avoided.

Next, referring to FIG. 4, FIG. 4 is a schematic diagram of a touch electronic device according to the fourth embodiment of the invention. The difference between the present embodiment and the previous embodiments is that the virtual key 115_5 is not limited to be disposed between the hot key 125 and the main touch region 110, but only needs to be disposed in the decoration region 120. In the present embodiment, the virtual key 115_5 can be disposed (for instance) at or on the right side of the hot key 125, but the invention is not limited thereto. Adjustments can be made according to actual design/application requirements for the disposition of the virtual key 115_5. It should be mentioned that, if the user wishes to deactivate the preset function of the hot key 125, it can be done through the operation of pressing the virtual key 115_5, such as by pressing and holding or repeatedly pressing, and the preset function of the hot key 125 can be deactivated. On the other hand, if the user wishes to activate the preset function of the hot key 125, it can be done through the operation of pressing the virtual key 115_5 again, and the preset function of the hot key 125 can be reactivated. In this way, the problem of inadvertently touching the hot key 125 can be effectively avoided when the user operates the touch electronic device 100.

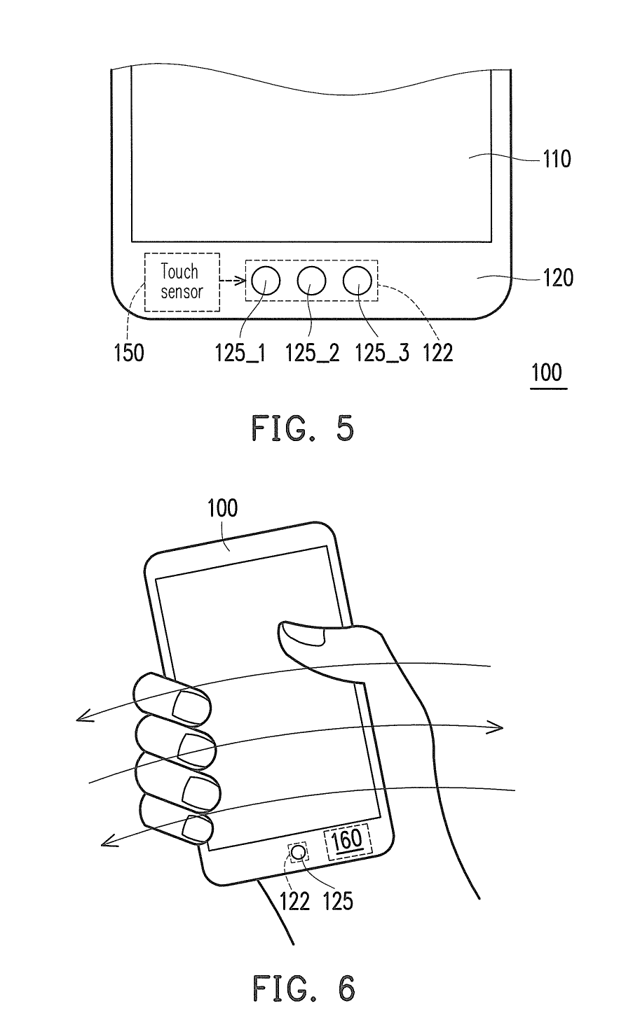

FIG. 5 is a schematic diagram of a touch electronic device according to the fifth embodiment of the invention. In the present embodiment, the assistant touch region 122 of the touch electronic device 100 includes three distinct hot keys 125_1, 125_2, and 125_3 (each having a different preset function) therein. In the present embodiment, only the three hot keys 125_1, 125_2, and 125_3 are used for explanation, but the invention is not limited thereto. It should be mentioned that, the sensing module (such as 115) in the touch electronic device 100 includes a touch sensor 150 (that is, 115 is implemented through 150). The touch sensor 150 can, for instance, be achieved by using an individual microcontroller unit (MCU) or a firmware in a master controller coupled to the hot keys 125_1, 125_2, and 125_3 for sensing the touch operation of the user to the hot keys 125_1, 125_2, and 125_3 in the touch electronic device 100, such as a press sequence of the hot keys 125_N(=1-3), to activate or deactivate the preset functions of the hot keys 125_1, 125_2, and 125_3. Specifically, the user can press the hot keys 125_1, 125_2, and 125_3 in sequence according to a preset press sequence of the hot keys 125_1, 125_2, and 125_3 in the touch electronic device 100, and the preset function of each of the hot keys 125_1, 125_2, and 125_3 can be activated or deactivated. However, in the present embodiment, the preset press sequence of the hot keys 125_1, 125_2, and 125_3 can be decided according to actual design/application requirements, and the preset press sequence can be a plurality of different combinations such as 125_1, 125_2, to 125_3 or 125_3, 125_2, to 125_1, but the invention is not limited thereto.

For instance, assuming the preset press sequence of the hot keys (125_N(=1-3)) in the touch electronic device 100 is 125_1, 125_{‘3}2, to 125_3, if the user decides to deactivate the preset functions of the hot keys (125_N(=1-3)), the user only needs to press the hot keys 125_1, 125_2, to 125_3 in sequence, and the preset functions of the hot keys (125_N(=1-3)) can be deactivated. And if the user decides to reactivate the preset functions of the hot keys (125_N(=1-3)), the user only needs to press the hot keys 125_1, 125_2, to 125_3 in sequence again, and the preset functions of the hot keys (125_N(=1-3)) can be reactivated. However, the press sequence may not be the same for activating and deactivating the preset functions of the hot keys. For instance, assuming the press sequence of deactivating the preset functions of the hot keys (125_N(=1-3)) in the touch electronic device 100 is, in order, 125_1, 125_2, to 125_3, if the user wishes to reactivate the preset functions of the of the hot keys (125_N(=1-3)), the user can also press the hot keys (125_N(=1-3)) according to a reverse order of the preset press sequence of the hot keys (125_N(=1-3)), such as by pressing 125_3, 125_2, to 125_1, to achieve the effect of activating the preset functions of the hot keys (125_N(=1-3)).

In addition to the above embodiments, the touch electronic device 100 can also activate or deactivate the preset function of the hot key 125 through different means, such as through shaking, voice input, and software control to activate or deactivate the preset function of the hot key 125 in the touch electronic device 100, but the invention is not limited thereto, and is specifically described below.

Specifically, using FIG. 6 as an example, FIG. 6 is a schematic diagram of a touch electronic device according to the sixth embodiment of the invention. The sensing module (such as 115) in the touch electronic device 100 includes a gravity sensor (G-sensor) 160 (that is, 115 is implemented through 160) for sensing a change in position when the user operates the touch electronic device 100 by, for instance, shaking vertically or horizontally, flipping, and shaking a plurality of times (as shown in FIG. 6), to activate or deactivate the preset function of the hot key 125 of the assistant touch region 122 on the touch electronic device 100. For instance, if the user decides to deactivate the preset function of the hot key 125, the user needs to shake the touch electronic device 100 back and forth twice, and the preset function of the hot key 125 can be deactivated. And if the user decides to reactivate the preset function of the hot key 125, the user needs to shake the touch electronic device 100 back and forth twice again, and the preset function of the hot key 125 can be reactivated. In the present embodiment, the direction and number of times the user shakes the touch electronic device 100 can be decided on actual design/application requirements, but the invention is not limited thereto.

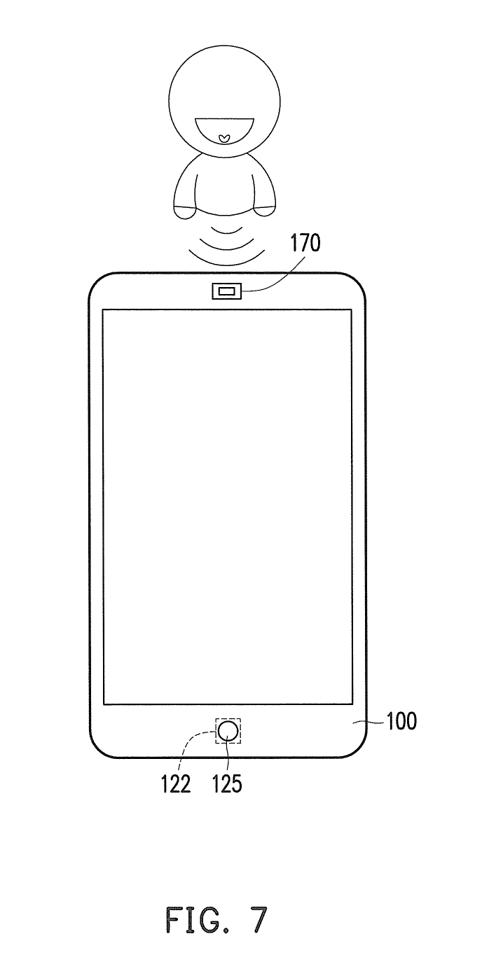

Using FIG. 7 as an example, FIG. 7 is a schematic diagram of a touch electronic device according to the seventh embodiment of the invention. The sensing module (such as 115) in the touch electronic device 100 includes a voice sensor 170 (that is, 115 is implemented through 170) for sensing the voice input of the user and to activate or deactivate the preset function of the hot key 125 of the assistant touch region 122 on the touch electronic device 100 (i.e., voice control). For instance, if the user decides to deactivate the preset function of the hot key 125, the user needs to input his voice to the touch electronic device 100, by using voice commands such as “stop hot key” and “deactivate hot key”, and the preset function of the hot key 125 can be deactivated. If the user decides to reactivate the preset function of the hot key 125, the user needs to input his voice to the touch electronic device 100 again, by using voice commands such as “activate hot key” and “start hot key”, and the preset function of the hot key 125 can be reactivated.

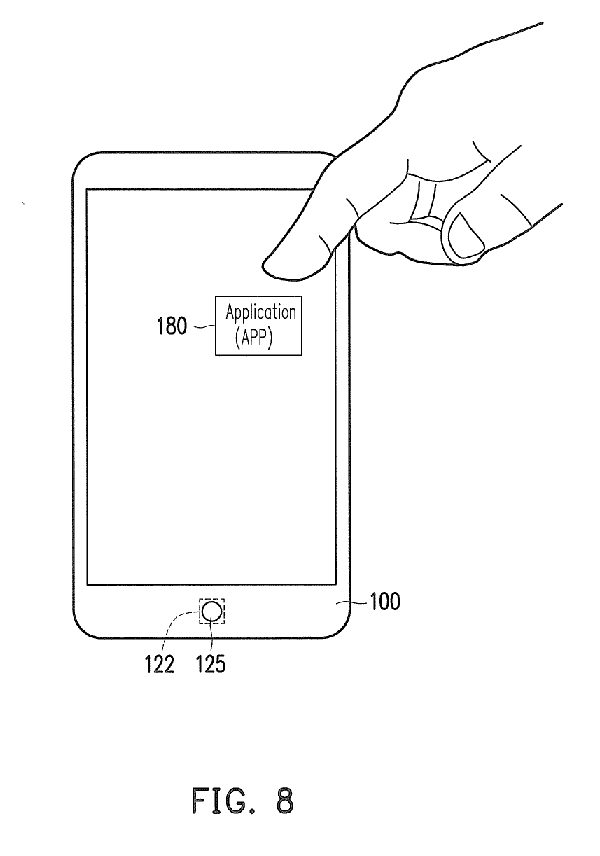

Using FIG. 8 as an example, FIG. 8 is a schematic diagram of a touch electronic device according to the eighth embodiment of the invention. The sensing module (such as 115) in the touch electronic device 100 includes an application 180 (APP) (that is, 115 is implemented through 180) for responding to whether the user started the application 180 in the touch electronic device 100 to activate or deactivate the preset function of the hot key 125 of the assistant touch region 122 on the touch electronic device 100. For instance, if the user decides to deactivate the preset function of the hot key 125, the user needs to first select and activate the application 180 in the touch electronic device 100, and the preset function of the hot key 125 can be activated or deactivated based on the indication provided by the application 180.

Although the assistant touch region 122 and the sensing module 115 in the above embodiments are only illustrated in (or within) the decoration region 120 of the touch electronic device 100, but the invention is not limited thereto. If the touch electronic device 100 does not have the decoration region 120 (that is to say, the touch electronic device 100 only has the main touch region 110), then the assistant touch region 122 and the sensing module 115 can be modified to be directly disposed in (or within, depending on actual design/application requirements) the main touch region 110. As long as the operation of the original main touch region 110 is not affected, similar technical effect/efficacy to the above embodiments can be achieved in this way.

Based on the above, the invention provides a touch electronic device capable of combining a plurality of methods for activating or deactivating the hot key (125), such as through the arrangement of the virtual key, the press sequence of the hot key, the change in position of the device, the voice input of the user, or the installation of the application (APP). Therefore, the problem of inadvertently touching the hot key (125) and starting a nonessential preset function is avoided when the user engages in operations such as touching and sliding on the main touch region (110) of the touch electronic device. As a result, the efficiency and convenience of operation by the user are significantly improved.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A touch electronic device, comprising:
a main touch region;
a decoration region disposed at or on at least one side of the main touch region;
an assistant touch region in the decoration region and having at least one hot key, wherein the at least one hot key is configured to execute a preset function; and
a sensing module configured to activate or deactivate the preset function of the at least one hot key.

2. The touch electronic device as recited in claim 1, wherein the sensing module comprises at least one virtual key, an actuation or operation thereof having a higher priority compared to the at least one hot key, the at least one virtual key is disposed in the decoration region, and the at least one virtual key is configured to activate or deactivate the preset function of the at least one hot key when the at least one virtual key and the at least one hot key are started at the same time.

3. The touch electronic device as recited in claim 2, wherein the at least one virtue key is disposed between the at least one hot key and the main touch region.

4. The touch electronic device as recited in claim 2, wherein the at least one virtue key surrounds a portion of the at least one hot key.

5. The touch electronic device as recited in claim 1, wherein the at least one hot key comprises a plurality of distinct hot keys, the sensing module comprises a touch sensor coupled to the hot keys, and the touch sensor is configured to sense a press sequence of the hot keys and determine whether the press sequence conforms to a preset press sequence to activate or deactivate the preset function of the at least one hot key.

6. The touch electronic device as recited in claim 1, wherein:
the sensing module comprises a gravity sensor for sensing a change in position of the touch electronic device to activate or deactivate the preset function of the at least one hot key;
the sensing module comprises a voice sensor for sensing a voice input of a user to the touch electronic device to activate or deactivate the preset function of the at least one hot key; or
the sensing module comprises an application and the preset function of the at least one hot key is activated or deactivated in response to whether the application is activated.

7. A touch electronic device, comprising:
a main touch region;
at least one hot key configured to execute a preset function; and
a sensing module configured to activate or deactivate the preset function of the at least one hot key.

8. The touch electronic device as recited in claim 7, further comprising:
a decoration region disposed at or on at least one side of the main touch region; and
an assistant touch region in the decoration region, wherein the at least one hot key is in the assistant touch region.

9. The touch electronic device as recited in claim 8, wherein the sensing module comprises at least one virtual key, an actuation thereof having a higher priority compared to the at least one hot key, the at least one virtual key is disposed in the decoration region, and the at least one virtual key is configured to activate or deactivate the preset function of the at least one hot key when the at least one virtual key and the at least one hot key are started at the same time.

10. The touch electronic device as recited in claim 9, wherein the at least one virtue key is disposed between the at least one hot key and the main touch region.

11. The touch electronic device as recited in claim 9, wherein the at least one virtue key surrounds a portion of the at least one hot key.

12. The touch electronic device as recited in claim 8, wherein the at least one hot key comprises a plurality of distinct hot keys, the sensing module comprises a touch sensor coupled to the hot keys, and the touch sensor is configured to sense a press sequence of the hot keys and determine whether the press sequence conforms to a preset press sequence to activate or deactivate the preset function of the at least one hot key.

13. The touch electronic device as recited in claim 8, wherein
the sensing module comprises a gravity sensor for sensing a change in position of the touch electronic device to activate or deactivate the preset function of the at least one hot key;
the sensing module comprises a voice sensor for sensing a voice input of a user to the touch electronic device to activate or deactivate the preset function of the at least one hot key; or
the sensing module comprises an application and the preset function of the at least one hot key is activated or deactivated in response to whether the application is activated.

14. A touch electronic device, comprising:
a main touch region;
a decoration region disposed at or on at least one side of the main touch region;
an assistant touch region in the decoration region and having at least one hot key, wherein the at least one hot key is configured to execute a preset function; and
a sensing module configured to avoid the execution of a nonessential preset function when a user inadvertently touches the at least one hot key during operation of the touch electronic device.

15. The touch electronic device as recited in claim 14, wherein the sensing module comprises at least one virtual key, an actuation or operation thereof having a higher priority compared to the at least one hot key, the at least one virtual key is disposed in the decoration region, and the at least one virtual key is configured to deactivate the preset function of the at least one hot key when the at least one virtual key and the at least one hot key are started at the same time.

16. The touch electronic device as recited in claim 15, wherein the at least one virtue key is disposed between the at least one hot key and the main touch region.

17. The touch electronic device as recited in claim 15, wherein the at least one virtue key surrounds a portion of the at least one hot key to be used as a separator between the at least one hot key and the main touch region.

18. The touch electronic device as recited in claim 15, wherein if finger of the user inadvertently presses the at least one virtual key and the at least one hot key successively or at the same time when sliding on the main touch region, then the preset function of the at least one hot key is deactivated.

19. The touch electronic device as recited in claim 14, wherein the main touch region is at least one of a capacitive touch screen, a resistive touch screen and an optical touch screen.

20. The touch electronic device as recited in claim 14, wherein the touch electronic device is an electronic device having touch function, and the electronic device is at least one of smart phone, a personal digital assistant (PDA) and a tablet PC.
